(19) United States
(12) Patent Application Publication
(10) Pub. No.: US 2025/0071636 A1
(43) Pub. Date: Feb. 27, 2025

(54) CELL RESELECTION METHOD, CELL RESELECTION PROCESSING METHOD, AND RELATED DEVICE

(71) Applicant: VIVO MOBILE COMMUNICATION CO., LTD., Dongguan (CN)

(72) Inventors: Yangyang WANG, Dongguan (CN); Xuanbing LIU, Dongguan (CN)

(73) Assignee: VIVO MOBILE COMMUNICATION CO., LTD., Dongguan (CN)

(21) Appl. No.: 18/942,303

(22) Filed: Nov. 8, 2024

Related U.S. Application Data
(63) Continuation of application No. PCT/CN2023/092427, filed on May 6, 2023.

(30) Foreign Application Priority Data
May 9, 2022 (CN) 202210501042.8

(51) Int. Cl. H04W 36/00; H04W 36/08; H04W 52/02

(52) U.S. Cl. CPC H04W 36/0085; H04W 36/08; H04W 52/0209

(57) ABSTRACT

A cell reselection method, a cell reselection processing method, and related devices are provided. The cell reselection method includes: receiving, by a terminal, a first message from a network side device. The first message includes first configuration information and second configuration information. The first configuration information includes configuration information of a first signal in a service area. The second configuration information includes configuration information of a first signal in a neighboring area. The cell reselection method further includes performing, by the terminal when the terminal is in a low-power state, low-power cell reselection-related measurement on the first signal based on the first message, to obtain measurement results. The Low-power cell reselection means to determine a to-be-camped-on cell after the terminal leaves the low-power state. The cell reselection method also includes performing, by the terminal, low-power cell reselection based on the measurement results when the terminal leaves the low-power state.

### CROSS-REFERENCE TO RELATED APPLICATIONS

This application is a continuation of International Application No. PCT/CN2023/092427, filed on May 6, 2023, which claims priority to Chinese Patent Application No. 202210501042.8, filed on May 9, 2022. The entire contents of each of the above-referenced applications are expressly incorporated herein by reference.

### TECHNICAL FIELD

This application pertains to the field of communication technologies, and specifically relates to a cell reselection method, a cell reselection processing method, and a related device.

### BACKGROUND

With the development of a communication system, a Low Power Wake-Up Signal (LP-WUS) is introduced into the communication system. For example, a network side device may trigger, by using the LP-WUS signal, a terminal to leave a low-power state. After the terminal leaves the low-power state, a main receiver usually needs to be turned on for cell search. In this case, network-wide search is usually required during cell search, and then reselection is performed to a target cell. Therefore, in a related art, after the terminal leaves the low-power state, a delay of performing cell reselection is relatively large.

### SUMMARY

Embodiments of this application provide a cell reselection method, a cell reselection processing method, and related devices.

According to a first aspect, a cell reselection method is provided, including:
receiving, by a terminal, a first message from a network side device, where the first message includes first configuration information and second configuration information, the first configuration information includes configuration information of a first signal in a service area, and the second configuration information includes configuration information of a first signal in a neighboring area;
performing, by the terminal in a case that the terminal is in a low-power state, low-power cell reselection-related measurement on the first signal based on the first message, to obtain measurement results, where low-power cell reselection means to determine a to-be-camped-on cell after the terminal leaves the low-power state; and
performing, by the terminal, low-power cell reselection based on the measurement results in a case that the terminal leaves the low-power state.

According to a second aspect, a cell reselection processing method is provided, including:
sending, by a network side device, a first message related to low-power state to a terminal; where
the first message includes first configuration information and second configuration information, the first configuration information includes configuration information of a first signal in a service area, the second configuration information includes configuration information of a first signal in a neighboring area, and the first signal is capable of being used by the terminal to perform low-power cell reselection-related measurement in a low-power state.

According to a third aspect, a cell reselection apparatus is provided, including:
a receiving module, configured to receive a first message from a network side device, where the first message includes first configuration information and second configuration information, the first configuration information includes configuration information of a first signal in a service area, and the second configuration information includes configuration information of a first signal in a neighboring area;
a measurement module, configured to perform, in a case that a terminal is in a low-power state, low-power cell reselection-related measurement on the first signal based on the first message, to obtain measurement results, where low-power cell reselection means to determine a to-be-camped-on cell after the terminal leaves the low-power state; and
a reselection module, configured to perform low-power cell reselection based on the measurement results in a case that the terminal leaves the low-power state.

According to a fourth aspect, a cell reselection processing apparatus is provided, including:
a sending module, configured to send a first message related to low-power state to a terminal; where
the first message includes first configuration information and second configuration information, the first configuration information includes configuration information of a first signal in a service area, the second configuration information includes configuration information of a first signal in a neighboring area, and the first signal is capable of being used by the terminal to perform low-power cell reselection-related measurement in a low-power state.

According to a fifth aspect, a terminal is provided. The terminal includes a processor and a memory, the memory stores a program or an instruction that can be run on the processor, and when the program or the instruction is executed by the processor, the steps of the method according to the first aspect are implemented.

According to a sixth aspect, a terminal is provided, including a processor and a communication interface. The communication interface is configured to receive a first message from a network side device, where the first message includes first configuration information and second configuration information, the first configuration information includes configuration information of a first signal in a service area, and the second configuration information includes configuration information of a first signal in a neighboring area. The processor is configured to: perform, in a case that the terminal is in a low-power state, low-power cell reselection-related measurement on the first signal based on the first message to obtain measurement results, where low-power cell reselection means to determine a to-be-camped-on cell after the terminal leaves the low-power state; and perform low-power cell reselection based on the measurement results in a case that the terminal leaves the low-power state.

According to a seventh aspect, a network side device is provided. The network side device includes a processor and a memory, the memory stores a program or an instruction that can be run on the processor, and when the program or the instruction is executed by the processor, the steps of the method according to the second aspect are implemented.

According to an eighth aspect, a network side device is provided, including a processor and a communication interface. The communication interface is configured to send a first message related to low-power state to a terminal, where the first message includes first configuration information and second configuration information, the first configuration information includes configuration information of a first signal in a service area, the second configuration information includes configuration information of a first signal in a neighboring area, and the first signal is capable of being used by the terminal to perform low-power cell reselection-related measurement in a low-power state.

According to a ninth aspect, a communication system is provided, including a terminal and a network side device. The terminal may be configured to perform the steps of the cell reselection method according to the first aspect, and the network side device may be configured to perform the steps of the cell reselection processing method according to the second aspect.

According to a tenth aspect, a readable storage medium is provided. The readable storage medium stores a program or an instruction, and when the program or the instruction is executed by a processor, the steps of the method according to the first aspect are implemented, or the steps of the method according to the second aspect are implemented.

According to an eleventh aspect, a chip is provided. The chip includes a processor and a communication interface. The communication interface is coupled to the processor, and the processor is configured to run a program or instructions, to implement the steps of the method according to the first aspect or the steps of the method according to the second aspect.

According to a twelfth aspect, a computer program product/program product is provided. The computer program product/program product is stored in a storage medium, and the computer program/program product is executed by at least one processor to implement the steps of the method according to the first aspect or the steps of the method according to the second aspect.

In embodiments of this application, because a network side device configures configuration information of a first signal in a service area and configuration information of a first signal in a neighboring area for a terminal by using a first message, it can be ensured that the terminal can work normally in a low-power working state. Therefore, the terminal may measure the first signal when the terminal is in the low-power working state, and may be directly reselected to a target cell based on measurement results, or may perform a cell search on one or more areas targetedly, and be reselected to a target cell, thereby reducing a delay of cell reselection.

### BRIEF DESCRIPTION OF DRAWINGS

FIG. 1 is a schematic diagram of a network structure to which embodiments of this application are applicable;

FIG. 2 is a flowchart of a cell reselection method according to an embodiment of the present application;

FIG. 3 is a flowchart of a cell reselection processing method according to an embodiment of the present application;

FIG. 4 is a structural diagram of a cell reselection apparatus according to an embodiment of this application;

FIG. 5 is a structural diagram of a cell reselection processing apparatus according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the term NR is used in most of the following description, although these technologies can also be applied to applications other than the NR system application, such as the 6^{th} Generation (6G) communication system.

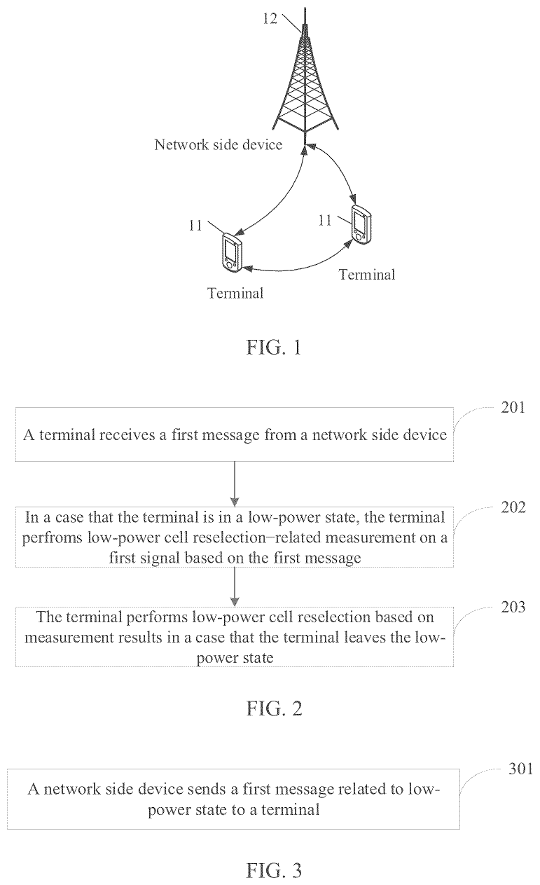

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer that is referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device may include a base station, a Wireless Local Area Networks (WLAN) access point, a WiFi node, or the like. The base station may be referred to as a NodeB, an Evolved Node B (eNB), an access point, a Base Transceiver Station (BTS), a radio base station, a radio transceiver, a Basic Service Set (BSS), an Extended Service Set (ESS), a home NodeB, a home eNB, a Transmission and Reception Point (TRP), or another proper term in the art. The base station is not limited to a specific technical term provided that a same technical effect is achieved. It should be noted that in the embodiments of this application, a base station in an NR system is merely used as an example for description, but does not limit a specific type of the base station.

For ease of understanding, some content involved in the embodiments of this application is described below.

### 1. Wake-Up Receiver Beacon

Currently, a terminal generally includes two parts: a main receiver and a wake-up receiver. The main interface is used to send and receive WiFi data, and the wake-up receiver is used to wake up the main interface. Before being woken up, the main interface is in a disabled state, and does not send or receive data. The wake-up receiver receives a wake-up signal sent by an Access Point (AP), and the wake-up signal may be an On-Off Keying (OOK) modulation signal, so that the wake-up receiver may detect the wake-up signal in an envelope detection manner, and power consumption can be reduced to hundreds of microwatts, thereby reducing power consumption of the terminal.

### 2. LP-WUS

The LP-WUS may be received by a Low Power Wake-Up Receiver (LP WUR), and the LP-WUS may be used to wake up a main communication module or the like. The terminal includes two modules. A first module is a main communication module, and is configured to send and receive mobile communication data. A second module is a low-power wake-up receiver module, and is configured to receive a low-power wake-up signal and a low-power beacon signal that are sent by a transmit end. The low-power wake-up signal is used to wake up a main communication module of a receive end, the low-power beacon signal is used to provide time reference information and other information for reception of the low-power wake-up signal, and may further provide wake-up link management. When the first module is not woken up by the second module, the first module is always in a disabled state, and does not send or receive data. When downlink data arrives, the second module detects a wake-up signal sent by the transmit end, and the wake-up signal includes information about the current terminal, the second module triggers the first module to switch from the disabled state to a working state, so as to receive and send data. The second module may be continuously enabled or discontinuously enabled. When the second module is enabled, the second module may receive a low-power wake-up signal and a low-power beacon signal.

With reference to the accompanying drawings, a cell reselection method provided in the embodiments of this application is described in detail below by using embodiments and application scenarios thereof.

Referring to FIG. 2, an embodiment of this application provides a cell reselection method. As shown in FIG. 2, the cell reselection method includes the following steps:

Step 201: A terminal receives a first message from a network side device, where the first message includes first configuration information and second configuration information, the first configuration information includes configuration information of a first signal in a service area, and the second configuration information includes configuration information of a first signal in a neighboring area.

Step 202: The terminal performs, in a case that the terminal is in a low-power state, low-power cell reselection-related measurement on the first signal based on the first message, to obtain measurement results, where low-power cell reselection means to determine a to-be-camped-on cell after the terminal leaves the low-power state.

Step 203: The terminal performs low-power cell reselection based on the measurement results in a case that the terminal leaves the low-power state.

In this embodiment of this application, there may be one or more first messages. When there are a plurality of first messages, the first configuration information and the second configuration information may be located in different first messages. The service area and the neighboring area may be collectively referred to as an area, and each area may include any one of the following:
a cell;
a Tracking Area (TA);
a RAN-based Notification Area; and
at least two predefined or preconfigured cells.

In some embodiments, the service area may correspond to at least one first signal, and one neighboring area corresponds to at least one first signal. First signals corresponding to different neighboring areas have different signal identifiers, and a first signal corresponding to the neighboring area and a first signal corresponding to the service area have different signal identifiers.

It should be noted that, in this embodiment of this application, a definition of the foregoing area (the service area and the neighboring area) is provided. In another embodiment, the definition of the area may be not provided, that is, configuration information of the first signal may be directly sent based on an existing cell reselection configuration, and the service area and the neighboring area are distinguished by mapping different first signals to different objects. The object may include a cell or a frequency, and generally, a plurality of cells or frequencies may be mapped to one first signal. In other words, in another embodiment, the concept of “area” may not be introduced, that is, the service area in this embodiment of this application may be understood as or replaced with a service object, and the neighboring area may be understood as or replaced with a neighboring object.

In some embodiments, the first signal is used for at least one of the following: ensuring synchronization between the terminal and the network side device and determining whether the terminal exits the low-power state, so that normal working of the terminal in the low-power state can be ensured. In some embodiments, the first signal may include a low-power beacon signal, a keep-alive signal, an LP-WUS, or a WUS. The low-power state is that a main receiver of the terminal is in a disabled or nearly-disabled state, and a low-power receiver of the terminal is in an enabled state. “Nearly-disabled” means that most functions of the main receiver are in a disabled state, and a small part of functions are in a running state. Leaving the low-power state means that the main receiver of the terminal is in an enabled state, and the low-power receiver of the terminal is in a disabled state.

It should be understood that, in this embodiment of this application, the first signal is used by the terminal to perform low-power cell reselection-related measurement when the terminal is in the low-power state.

In this embodiment of this application, because the network side device configures the configuration information of the first signal in the service area and the configuration information of the first signal in the neighboring area for the terminal by using the first message, it can be ensured that the terminal can work normally in a low-power working state. Therefore, the terminal may measure the first signal when the terminal is in the low-power working state, and may be directly reselected to a target cell based on measurement results, or may perform a cell search on one or more areas targetedly, and be reselected to a target cell, thereby reducing a delay of cell reselection.

In some embodiments, the first configuration information further includes at least one of the following:
a first parameter corresponding to the service area, where the first parameter is used to determine whether to perform low-power cell reselection; and
a second parameter corresponding to the service area, where the second parameter is used to determine a ranking of the service area in a case that the terminal is in the low-power state.

In some embodiments, the measurement results include at least one of a measurement quantity and an evaluation quantity, and the first parameter includes at least one of the following:
a first measurement threshold, where the first measurement threshold is used to determine, based on an evaluation quantity or a measurement quantity of the service area, whether to perform low-power cell reselection-related measurement on the neighboring area, and the evaluation quantity of the service area is used to determine whether to perform low-power cell reselection and/or whether to perform low-power cell reselection-related measurement on the neighboring area;
a second measurement threshold, where the second measurement threshold is used to determine, based on the evaluation quantity or the measurement quantity of the service area, whether to perform low-power cell reselection-related measurement on a neighboring area whose priority is lower than or equal to a priority of the service area;
a parameter used to calculate the evaluation quantity of the service area;
a first reselection threshold, where the first reselection threshold is used to determine whether to perform low-power cell reselection to the neighboring area;
a second reselection threshold, where the second reselection threshold is used to determine whether to perform low-power cell reselection to the neighboring area whose priority is lower than the priority of the service area; and
a low-power cell reselection priority of the service area.

In this embodiment of this application, after the terminal enters the low-power state, the terminal may perform low-power cell reselection-related measurement on the service area, to obtain a measurement quantity of the service area, and an evaluation quantity of the service area may be calculated based on the measurement quantity of the service area.

In some embodiments, the terminal may determine, based on the measurement quantity of the service area, whether to perform low-power cell reselection-related measurement on the neighboring area, and may determine, based on the evaluation quantity of the service area, whether to perform low-power cell reselection-related measurement and/or whether to perform low-power cell reselection-related measurement on the neighboring area.

For the first measurement threshold, if the measurement quantity of the service area or the evaluation quantity of the service area is less than or not greater than the first measurement threshold, low-power cell reselection-related measurement is performed on the neighboring area.

For the second measurement threshold, if the measurement quantity of the service area or the evaluation quantity of the service area is less than or not greater than the second measurement threshold, low-power cell reselection-related measurement is performed on the neighboring area whose priority is lower than or equal to the priority of the service area.

For the first reselection threshold, only when the evaluation quantity of the service area is less than or equal to the first reselection threshold, the terminal considers to reselect to a low-power cell of the neighboring area.

For the second reselection threshold, only when the evaluation quantity of the service area is less than or equal to the second reselection threshold, the terminal considers to perform low-power cell reselection to the neighboring area whose priority is lower than the priority of the service area.

In some embodiments, the first parameter further includes:
a first evaluation period, where the first evaluation period is associated with at least one of the first measurement threshold and the second measurement threshold.

In this embodiment of this application, the first evaluation duration is duration to evaluate whether to perform measurement on the neighboring area. For example, if the measurement quantity of the service area or the evaluation quantity of the service area within the first evaluation duration is less than or not greater than the second measurement threshold, low-power cell reselection-related measurement is performed on the neighboring area whose priority is lower than or equal to the priority of the service area.

In some embodiments, the second parameter includes a hysteresis value.

In this embodiment of this application, the hysteresis value is used to determine a ranking value of the service area according to a target ranking rule, and the target ranking rule may be an R criterion (ranking criteria) in some embodiments. For example, for a reselectable area with a same priority that is determined based on a target reselection manner, a better area may be selected according to a low-power ranking rule for cell reselection; or in a case that a priority of a target area is configured, for a neighboring area with a same priority as the service area, a better area may be determined from the neighboring areas by using the target ranking rule for cell reselection. In this way, the reliability of communication can be improved. It should be noted that the target reselection manner is used to determine a reselectable neighboring area. It should be understood that the target reselection manner may also be understood as a reselection criterion or criterion. In other words, the terminal may consider that a reselectable neighboring area determined based on the target reselection manner satisfies the reselection criterion or criterion.

In some embodiments, the parameter used to calculate the evaluation quantity of the service area may include at least one of the following:
an offset value of the evaluation quantity calculated in the current area;
a minimum required received power value;
an offset of a minimum required received power value;
a minimum required quality value; and
an offset of a minimum required quality value.

A received power value may be Reference Signal Received Power (RSRP) for a measurement quantity of a first signal in an area. A quality value may be Reference Signal Received Quality (RSRQ) for a measurement quantity of a first signal in an area.

In some embodiments, the first parameter may further include second evaluation duration. In this case, only when the evaluation quantity of the service area in the second evaluation duration satisfies the reselection criterion or the reselection criterion and/or an evaluation quantity of the neighboring area satisfies the reselection criterion or the reselection criterion in the second evaluation duration, the terminal may consider that the neighboring area satisfies the selection rule or the reselection criterion. The second evaluation duration is duration in which the terminal determines evaluation duration of a reselectable neighboring area based on the target reselection manner.

In some embodiments, the configuration information of the first signal includes at least one of the following:
an identifier of the first signal;
a sequence corresponding to the first signal;
a format of the first signal;
a monitoring occasion of the first signal;
a cell reselection priority indicator in a low-power state of the first signal;
a frequency corresponding to the first signal;
a cell corresponding to the first signal; and
a Radio Access Type (RAT) corresponding to the first signal.

In this embodiment of this application, if the configuration information of the first signal is not configured with a cell reselection priority in the low-power state, a cell reselection priority of the first signal may be agreed in a protocol. For example, the terminal considers that the first signal has a highest or lowest cell reselection priority or has a cell reselection priority that is the same as that of the service area.

In some embodiments, an area corresponding to the first signal may include at least one cell, and the at least one cell is a cell in a cell list, that is, the first signal corresponds to the cell list.

In some embodiments, when the first signal is a low-power beacon signal or a keep-active signal, the monitoring occasion of the first signal includes at least one of the following:
a start location of a cycle of the first signal;
a length of the cycle of the first signal;
a quantity of first signals included in one cycle of the first signal;
a length of one first signal; and
a time offset within one cycle of the first signal.

In some embodiments, when the first signal is an LP-WUS or a WUS, the monitoring occasion of the first signal includes:
a WUS Discontinuous Reception (DRX) start location;
WUS DRX duration; and
a WUS DRX cycle.

In some embodiments, the RAT may include LTE, NR, and the like.

In some embodiments, the second configuration information further includes at least one of the following:
a third parameter corresponding to the neighboring area, where the third parameter is used to determine whether to perform low-power cell reselection;
a fourth parameter corresponding to the neighboring area, where the fourth parameter is used to determine a ranking of the service area in the low-power state of the terminal; and
a neighboring area monitoring occasion.

In this embodiment of this application, the third parameter may include at least one of the following:
a parameter used to calculate an evaluation quantity of the neighboring area, where the evaluation quantity of the neighboring area is used to determine whether to perform low-power cell reselection to the neighboring area;
a third reselection threshold, where the third reselection threshold is used to determine whether to perform low-power cell reselection to the neighboring area;
a fourth reselection threshold, where the fourth reselection threshold is used to determine whether to perform low-power cell reselection to a first area, and the first area is a neighboring area whose priority is greater than a priority of the service area;
a fifth reselection threshold, where the fifth reselection threshold is used to determine whether to perform low-power cell reselection to a second area, and the second area is a neighboring area whose priority is equal to the priority of the service area;
a sixth reselection threshold, where the sixth reselection threshold is used to determine whether to perform low-power cell reselection to a third area, and the third area is a neighboring area whose priority is lower than the priority of the service area;
second evaluation duration, where the second evaluation duration is evaluation duration in which the terminal determines a reselectable neighboring area based on a target reselection manner; and
a low-power cell reselection priority of the neighboring area.

In this embodiment of this application, when the evaluation quantity of the neighboring area is greater than or equal to a corresponding target reselection threshold, it is determined that the reselection criterion is met, and only in this case, the terminal considers to perform low-power cell reselection on the neighboring area. The target reselection threshold is any one of the third reselection threshold, the fourth reselection threshold, the fifth reselection threshold, and the sixth reselection threshold.

In some embodiments, the fourth parameter includes an offset between areas. The offset between areas is used to calculate a ranking value obtained after neighboring areas are ranked in the target ranking manner.

In some embodiments, the neighboring area monitoring occasion is determined based on either of the following: a monitoring period; and a monitoring start position and monitoring duration.

The neighboring area monitoring occasion may be understood as an occasion in which the terminal monitors the first signal in the neighboring area. In some embodiments, first signals in the neighboring area may be consecutive, but UE does not continuously monitor the first signals in the neighboring area, and monitors the first signal corresponding to the neighboring area only in the neighboring area monitoring occasion. The UE monitors only a first signal in one neighboring area at one moment.

It should be understood that the monitoring period may be a positive integer K, indicating that a first signal in this area is monitored once every K preset cycles. The monitoring start location may be a start point, or may be an offset value relative to a reference first signal. The reference first signal may be a first signal included in the service area or a first signal corresponding to one neighboring area.

In some embodiments, the performing, by the terminal in a case that the terminal is in a low-power state, low-power cell reselection-related measurement on the first signal based on the first message, to obtain measurement results includes:
in a case that the terminal is in the low-power state, performing, by the terminal, low-power cell reselection-related measurement on the first signal in the service area based on the first message, to obtain measurement results of the service area; and
performing, by the terminal, low-power cell reselection-related measurement on first signals in N neighboring areas, where the N neighboring areas are determined based on the measurement results of the service area and a target measurement manner, and the target measurement manner is used to determine whether a neighboring area is to be measured.

In some embodiments, the measurement results include at least one of a measurement quantity and an evaluation quantity, and the target measurement manner includes at least one of the following:
performing low-power cell reselection-related measurement on the neighboring area when a measurement quantity or an evaluation quantity of the service area is less than or equal to a first measurement threshold; and
always performing low-power cell reselection-related measurement on a first area, and in a case that the measurement quantity or the evaluation quantity of the service area is less than or equal to a second measurement threshold, performing low-power cell reselection-related measurement on a second area and a third area; where
the first area is a neighboring area whose priority is greater than a priority of the service area, the second area is a neighboring area whose priority is equal to the priority of the service area, the third area is a neighboring area whose priority is lower than the priority of the service area, the first measurement threshold is used to determine, based on the measurement quantity or the evaluation quantity of the service area, whether to perform low-power cell reselection-related measurement on the neighboring area, and the second measurement threshold is used to determine, based on the measurement quantity or the evaluation quantity of the service area, whether to perform low-power cell reselection-related measurement on a neighboring area whose priority is equal to or lower than the priority of the service area.

It should be understood that performing low-power cell reselection-related measurement on the neighboring area may be understood as performing measurement on the first signal corresponding to the neighboring area. If the terminal does not support a neighboring area, the terminal does not perform low-power cell reselection-related measurement on the neighboring area. For example, if a frequency associated with or corresponding to a neighboring area is not a frequency supported by the terminal, the terminal does not perform low-power cell reselection-related measurement on the neighboring area. For another example, if a TA associated with or corresponding to a neighboring area is a part of forbidden tracking areas for roaming of a Public Land Mobile Network (PLMN) selected by the terminal, the terminal does not perform low-power cell reselection-related measurement on the neighboring area.

Further, in some embodiments, evaluation duration limitation may be further imposed on the target measurement manner. For example, the target measurement manner includes at least one of the following:
performing low-power cell reselection-related measurement on the neighboring area when a measurement quantity or an evaluation quantity of the service area within the first evaluation duration is less than or equal to a first measurement threshold; and
always performing low-power cell reselection-related measurement on a first area, and in a case that the measurement quantity or the evaluation quantity of the service area within the first evaluation duration is less than a second measurement threshold, performing low-power cell reselection-related measurement on a second area and a third area, where the first area is a neighboring area whose priority is higher than the priority of the service area, the second area is a neighboring area whose priority is equal to the priority of the service area, and the third are is a neighboring area whose priority is lower than the priority of the service area.

In this embodiment of this application, because a low-power cell reselection criterion is further specified, the terminal may also perform low-power cell reselection-related measurement on the neighboring area when the terminal is in the low-power state, so that a condition for enabling the terminal to enter the low-power state is relaxed, thereby further saving power.

In some embodiments, the performing, by the terminal, low-power cell reselection based on the measurement results in a case that the terminal leaves the low-power state includes:
in a case that the terminal leaves the low-power state, performing, by the terminal, low-power cell reselection based on the measurement results and a target reselection manner; where
the target reselection manner is used to determine a reselectable neighboring area.

In some embodiments, the target reselection manner includes at least one of the following:
performing low-power cell reselection to the neighboring area in a case that a measurement quantity or an evaluation quantity of the neighboring area is greater than a third reselection threshold;
performing low-power cell reselection to the neighboring area in a case that a measurement quantity or an evaluation quantity of the service area is less than or equal to a first reselection threshold and a measurement quantity or an evaluation quantity of the neighboring area is greater than or equal to a third reselection threshold;
performing low-power cell reselection to a first area in a case that a measurement quantity or an evaluation quantity of the first area is greater than or equal to a fourth reselection threshold, where the first area is a neighboring area whose priority is greater than a priority of the service area;
performing low-power cell reselection to a second area in a case that a measurement quantity or an evaluation quantity of the second area is greater than or equal to a fifth reselection threshold, where the second area is a neighboring area whose priority is equal to a priority of the service area;
performing low-power cell reselection to a second area in a case that a measurement quantity or an evaluation quantity of the service area is less than or equal to a second reselection threshold and a measurement quantity or an evaluation quantity of the second area is greater than or equal to a fifth reselection threshold;
performing low-power cell reselection to a third area in a case that a measurement quantity or an evaluation quantity of the service area is less than or equal to a second reselection threshold and a measurement quantity or an evaluation quantity of the third area is greater than or equal to a sixth reselection threshold, where the third area is a neighboring area whose priority is lower than a priority of the service area; and
ranking the second area based on a target ranking manner, and performing low-power cell reselection to L second areas with higher rankings, where L is a positive integer; where
the first reselection threshold is used to determine whether to perform low-power cell reselection to the neighboring area, the second reselection threshold is used to determine whether to perform low-power cell reselection to a neighboring area whose priority is lower than the priority of the service area, the third reselection threshold is used to determine whether to perform low-power cell reselection to the neighboring area, the fourth reselection threshold is used to determine whether to perform low-power cell reselection to the first area, the fifth reselection threshold is used to determine whether to perform low-power cell reselection to the second area, and the sixth reselection threshold is used to determine whether to perform low-power cell reselection to the third area. Further, in some embodiments, evaluation duration limitation may be further imposed on the low-power cell reselection criterion. For example, the low-power cell reselection criterion includes at least one of the following:
performing low-power cell reselection to the neighboring area in a case that a measurement quantity or an evaluation quantity of the neighboring area is greater than a third reselection threshold within the second evaluation duration;
performing low-power cell reselection to the neighboring area in a case that a measurement quantity or an evaluation quantity of the service area is less than or equal to a first reselection threshold and a measurement quantity or an evaluation quantity of the neighboring area is greater than or equal to a third reselection threshold within the second evaluation duration;
performing low-power cell reselection to a first area in a case that a measurement quantity or an evaluation quantity of the first area is greater than or equal to a fourth reselection threshold within the second evaluation duration, where the first area is a neighboring area whose priority is greater than a priority of the service area;
performing low-power cell reselection to a second area in a case that a measurement quantity or an evaluation quantity of the second area is greater than or equal to a fifth reselection threshold within the second evaluation duration, where the second area is a neighboring area whose priority is equal to a priority of the service area;
performing low-power cell reselection to a third area in a case that a measurement quantity or an evaluation quantity of the service area is less than or equal to a second reselection threshold and a measurement quantity or an evaluation quantity of the third area is greater than or equal to a sixth reselection threshold within the second evaluation duration, where the third area is a neighboring area whose priority is lower than a priority of the service area; and
ranking the second area in the second evaluation duration based on a target ranking manner, and performing low-power cell reselection to L second areas with higher rankings, where L is a positive integer.

In some embodiments, before the terminal performs evaluation in the target ranking manner, the terminal further needs to ensure that working duration of the terminal in a low-power working state exceeds T, and a value of T may also be determined by using at least one of protocol agreed, network side device configuration, or network side device preconfiguration. If T is exceeded, evaluation is performed in the target ranking manner; otherwise, the terminal does not perform evaluation in the target ranking manner.

In some embodiments, the target ranking manner includes at least one of the following:
a ranking value of the service area is equal to a result of reference signal received quality of a first signal in the service area plus a hysteresis value of the service area, or a ranking value of the service area is equal to a result of reference signal received quality of a first signal in the service area plus a hysteresis value of the service area minus a temporary offset of the service area; and
a ranking value of the neighboring area is equal to a result of reference signal received quality of a first signal in the neighboring area minus an offset between areas, or a ranking value of the neighboring area is equal to a result of reference signal received quality of a first signal in the neighboring area minus an offset between areas and a temporary offset of the neighboring area.

In some embodiments, the measurement quantity satisfies at least one of the following:
in a case that a target area includes one first signal, a measurement quantity of the target area is a measurement quantity of the first signal; and
in a case that a target area includes at least two first signals, a measurement quantity of the target area is determined based on measurement quantities of the at least two first signals; where
the target area is the service area or the neighboring area.

In some embodiments, in a case that the target area includes at least two first signals, the measurement quantity of the target area satisfies at least one of the following:
the measurement quantity of the target area is a maximum measurement quantity in the measurement quantities of the at least two first signals, or the measurement quantity of the target area is a minimum measurement quantity in the measurement quantities of the at least two first signals, or the measurement quantity of the target area is an average value of the measurement quantities of the at least two first signals; and
the measurement quantity of the target area is a measurement quantity of a first signal with a highest measurement quantity priority in the at least two first signals.

In some embodiments, in a case that a low-power cell reselection priority is configured for the target area, a priority of the target area is the low-power cell reselection priority; and
in a case that no low-power cell reselection priority is configured for the target area, a priority of the target area is determined based on at least one of the following: determining, by the terminal, that the priority of the target area is a highest priority, a lowest priority, or a preset priority; in a case that the target area includes one first signal and a cell reselection priority is configured for the first signal, determining the cell reselection priority of the first signal as the priority of the target area; in a case that the target area includes at least two first signals and a cell reselection priority is configured for only one of the first signals, determining the cell reselection priority of the first signal as the priority of the target area; and in a case that the target area includes at least two first signals and a cell reselection priority is configured for M first signals in the at least two first signals, determining a highest priority, a lowest priority, or a preset priority in cell reselection priorities of the M first signals as the priority of the target area, where M is an integer greater than 1; where
the target area is the service area or the neighboring area.

In some embodiments, the evaluation quantity includes at least one of the following:
an area selection received power value, where the area selection received power value is determined based on reference signal received power in the measurement quantity of the target area, and the target area is the service area or the neighboring area; and
an area selection quality value, where the area selection quality value is determined based on reference signal received quality in the measurement quantity of the target area.

In this embodiment of this application, an area selection received power value of the service area may be calculated based on the reference signal received power and an evaluation quantity-related parameter in the measurement quantity of the service area, and an area selection received power value of the neighboring area may be calculated based on the reference signal received power and an evaluation quantity-related parameter in the measurement quantity of the neighboring area. Similarly, an area selection quality value of the service area may be calculated based on the reference signal received quality and the evaluation quantity-related parameter in the measurement quantity of the service area, and an area selection quality value of the neighboring area may be calculated based on the reference signal received quality and the evaluation quantity-related parameter in the measurement quantity of the neighboring area.

In some embodiments, the performing, by the terminal, low-power cell reselection based on the measurement results in a case that the terminal leaves the low-power state includes any one of the following:

Manner 1: The terminal performs low-power cell reselection to N1 neighboring areas, where N1 is a positive integer, the N1 neighboring areas are determined based on the measurement results and at least one of a target ranking manner, a priority of an area, a target reselection manner, and a terminal implementation, and the target reselection manner is used to determine a reselectable neighboring area.

Manner 2: The terminal performs a cell search in the service area and all neighboring areas based on any one of the following: searching for, in a first order, at least one of a frequency and a cell corresponding to each area in the service area and all the neighboring areas, where a neighboring area determined based on the target reselection manner is located before another neighboring area in the first order; searching for at least one of a frequency and a cell corresponding to each area in the service area and all the neighboring areas in descending order of priorities; searching for at least one of a frequency and a cell corresponding to each area in the service area and all the neighboring areas in descending order of strength of first signals; searching, based on an order determined by the terminal, for at least one of a frequency or a cell corresponding to each area in the service area and all the neighboring areas; and searching, based on a high-to-low order determined based on the target ranking manner, for at least one of a frequency and a cell corresponding to each area in the service area and all the neighboring areas.

In this embodiment of this application, because the service area may include a plurality of cells, performing a cell search in the service area may be understood as performing a cell search in another neighboring area except the current serving cell in the service area.

It should be understood that, for the manner 1, when the terminal performs low-power cell reselection to N1 neighboring areas, and the N1 neighboring areas include at least two cells, the terminal may directly perform a cell search on the N1 neighboring areas. Because a cell search range is reduced, cell reselection duration of a low-power terminal can be shortened. When the terminal performs low-power cell reselection to the N1 neighboring areas, and the N1 neighboring areas include one cell, the terminal may directly reselect to the cell, thereby shortening cell reselection duration of a low-power terminal.

For the manner 2, when the terminal may search for a cell that the terminal considers that the terminal can camp at priority, the terminal may quickly search for a target cell that satisfies a cell reselection condition, thereby reducing a cell search delay and shortening cell reselection duration of a low-power terminal.

It should be noted that, for a case that a quantity of neighboring areas included in the N1 neighboring areas, a quantity of cells, and a priority of the neighboring area differ, correspondingly performed cell reselection is in different cases. For example, in some embodiments, that the terminal performs low-power cell reselection to N1 neighboring areas includes at least one of the following:
in a case that N1 is equal to 1 and the N1 neighboring areas include at least two cells, exiting, by the terminal, a low-power working state, and after exiting the low-power working state, performing a cell search on frequencies corresponding to the N1 neighboring areas, or performing a cell search on a cell list associated with frequencies corresponding to the N1 neighboring areas;
in a case that N1 is equal to 1 and the N1 neighboring areas include one cell, exiting, by the terminal, a low-power working state, and camping on the cell after exiting the low-power working state;
in a case that N1 is greater than 1 and a target neighboring area in the N1 neighboring areas includes at least two cells, exiting, by the terminal, a low-power working state, and after exiting the low-power working state, performing a cell search on a frequency corresponding to the target neighboring area, or performing a cell search on a cell list associated with a frequency corresponding to the target neighboring area, where the target neighboring area is N2 neighboring areas determined based on the target ranking manner, and N2 is a positive integer less than or equal to N1; and
in a case that N1 is greater than 1, performing, by the terminal, a cell search in the N1 neighboring areas based on any one of the following: searching for at least one of a frequency and a cell corresponding to the neighboring area in descending order of priorities; searching for at least one of a frequency and a cell corresponding to the neighboring area in descending order of strength of first signals; searching, based on an order determined by the terminal, for at least one of a frequency and a cell corresponding to the neighboring area; and searching, based on a high-to-low order determined based on the target ranking manner, for at least one of a frequency and a cell corresponding to the neighboring area.

As shown in FIG. 3, an embodiment of this application further provides a cell reselection processing method. As shown in FIG. 3, the cell reselection processing method includes the following steps:

Step 301: A network side device sends a first message related to low-power state to a terminal.

The first message includes first configuration information and second configuration information, the first configuration information includes configuration information of a first signal in a service area, the second configuration information includes configuration information of a first signal in a neighboring area, and the first signal is capable of being used by the terminal to perform low-power cell reselection-related measurement in a low-power state.

In some embodiments, the first configuration information further includes at least one of the following:
a first parameter corresponding to the service area, where the first parameter is used to determine whether to perform low-power cell reselection; and
a second parameter corresponding to the service area, where the second parameter is used to determine a ranking of the service area in a case that the terminal is in the low-power state.

In some embodiments, the measurement results include at least one of a measurement quantity and an evaluation quantity, and the first parameter includes at least one of the following:
a first measurement threshold, where the first measurement threshold is used to determine, based on an evaluation quantity or a measurement quantity of the service area, whether to perform low-power cell reselection-related measurement on the neighboring area, and the evaluation quantity of the service area is used to determine whether to perform low-power cell reselection and/or whether to perform low-power cell reselection-related measurement on the neighboring area;
a second measurement threshold, where the second measurement threshold is used to determine, based on the evaluation quantity or the measurement quantity of the service area, whether to perform low-power cell reselection-related measurement on a neighboring area whose priority is lower than or equal to a priority of the service area;
a parameter used to calculate the evaluation quantity of the service area;
a first reselection threshold, where the first reselection threshold is used to determine whether to perform low-power cell reselection to the neighboring area;
a second reselection threshold, where the second reselection threshold is used to determine whether to perform low-power cell reselection to the neighboring area whose priority is lower than the priority of the service area; and
a low-power cell reselection priority of the service area.

In some embodiments, the first parameter further includes:
a first evaluation period, where the first evaluation period is associated with at least one of the first measurement threshold and the second measurement threshold.

In some embodiments, the measurement quantity satisfies at least one of the following:
in a case that the service area includes one first signal, a measurement quantity of the service area is a measurement quantity of the first signal; and
in a case that the service area includes at least two first signals, a measurement quantity of the service area is determined based on measurement quantities of the at least two first signals.

In some embodiments, in a case that the service area includes at least two first signals, the measurement quantity of the service area satisfies at least one of the following:
the measurement quantity of the service area is a maximum measurement quantity in the measurement quantities of the at least two first signals, or the measurement quantity of the service area is a minimum measurement quantity in the measurement quantities of the at least two first signals, or the measurement quantity of the service area is an average value of the measurement quantities of the at least two first signals; and
the measurement quantity of the service area is a measurement quantity of a first signal with a highest measurement quantity priority in the at least two first signals.

In some embodiments, the second parameter includes a hysteresis value.

In some embodiments, the configuration information of the first signal includes at least one of the following:
an identifier of the first signal;
a sequence corresponding to the first signal;
a format of the first signal;
a monitoring occasion of the first signal;
a cell reselection priority indicator in a low-power state of the first signal;
a frequency corresponding to the first signal;
a cell corresponding to the first signal; and
a radio access type corresponding to the first signal.

In some embodiments, the second configuration information further includes at least one of the following:
a third parameter corresponding to the neighboring area, where the third parameter is used to determine whether to perform low-power cell reselection;
a fourth parameter corresponding to the neighboring area, where the fourth parameter is used to determine a ranking of the service area in the low-power state of the terminal; and
a neighboring area monitoring occasion.

In some embodiments, the measurement results include an evaluation quantity, and the third parameter includes at least one of the following:
a parameter used to calculate an evaluation quantity of the neighboring area, where the evaluation quantity of the neighboring area is used to determine whether to perform low-power cell reselection to the neighboring area;
a third reselection threshold, where the third reselection threshold is used to determine whether to perform low-power cell reselection to the neighboring area;
a fourth reselection threshold, where the fourth reselection threshold is used to determine whether to perform low-power cell reselection to a first area, and the first area is a neighboring area whose priority is greater than a priority of the service area;
a fifth reselection threshold, where the fifth reselection threshold is used to determine whether to perform low-power cell reselection to a second area, and the second area is a neighboring area whose priority is equal to the priority of the service area;
a sixth reselection threshold, where the sixth reselection threshold is used to determine whether to perform low-power cell reselection to a third area, and the third area is a neighboring area whose priority is lower than the priority of the service area;
second evaluation duration, where the second evaluation duration is evaluation duration in which the terminal determines a reselectable neighboring area based on a target reselection manner; and
a low-power cell reselection priority of the neighboring area.

In some embodiments, the fourth parameter includes an offset between areas.

In some embodiments, the neighboring area monitoring occasion is determined based on either of the following: a monitoring period; and a monitoring start position and monitoring duration.

In some embodiments, the priority satisfies at least one of the following:
in a case that a low-power cell reselection priority is configured for the target area, a priority of the target area is the low-power cell reselection priority; and
in a case that no low-power cell reselection priority is configured for the target area, a priority of the target area is determined based on any one of the following: determining that the priority of the target area is a highest priority, a lowest priority, or a preset priority; in a case that the target area includes one first signal and a cell reselection priority is configured for the first signal, determining the cell reselection priority of the first signal as the priority of the target area; in a case that the target area includes at least two first signals and a cell reselection priority is configured for only one of the first signals, determining the cell reselection priority of the first signal as the priority of the target area; and in a case that the target area includes at least two first signals and a cell reselection priority is configured for M first signals in the at least two first signals, determining a highest priority, a lowest priority, or a preset priority in cell reselection priorities of the M first signals as the priority of the target area, where M is an integer greater than 1; where
the target area is the service area or the neighboring area.

In some embodiments, the evaluation quantity includes at least one of the following:
an area selection received power value, where the area selection received power value is determined based on reference signal received power in the measurement quantity of the target area, and the target area is the service area or the neighboring area; and
an area selection quality value, where the area selection quality value is determined based on reference signal received quality in the measurement quantity of the target area.

The cell reselection method provided in this embodiment of this application may be performed by a cell reselection apparatus. In this embodiment of this application, the cell reselection apparatus according to an embodiment of this application is described by using an example in which the cell reselection apparatus performs the cell reselection method.

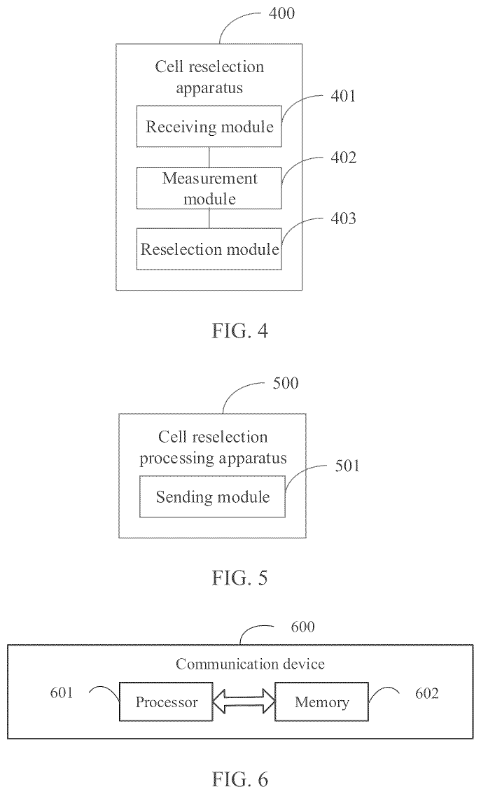

Referring to FIG. 4, an embodiment of this application provides a cell reselection apparatus. As shown in FIG. 4, the cell reselection apparatus 400 includes:
a receiving module 401, configured to receive a first message from a network side device, where the first message includes first configuration information and second configuration information, the first configuration information includes configuration information of a first signal in a service area, and the second configuration information includes configuration information of a first signal in a neighboring area;
a measurement module 402, configured to perform, in a case that a terminal is in a low-power state, low-power cell reselection-related measurement on the first signal based on the first message, to obtain measurement results, where low-power cell reselection means to determine a to-be-camped-on cell after the terminal leaves the low-power state; and
a reselection module 403, configured to perform low-power cell reselection based on the measurement results in a case that the terminal leaves the low-power state.

In some embodiments, the first configuration information further includes at least one of the following:
a first parameter corresponding to the service area, where the first parameter is used to determine whether to perform low-power cell reselection; and
a second parameter corresponding to the service area, where the second parameter is used to determine a ranking of the service area in a case that the terminal is in the low-power state.

In some embodiments, the measurement results include at least one of a measurement quantity and an evaluation quantity, and the first parameter includes at least one of the following:
a first measurement threshold, where the first measurement threshold is used to determine, based on an evaluation quantity or a measurement quantity of the service area, whether to perform low-power cell reselection-related measurement on the neighboring area, and the evaluation quantity of the service area is used to determine whether to perform low-power cell reselection and/or whether to perform low-power cell reselection-related measurement on the neighboring area;
a second measurement threshold, where the second measurement threshold is used to determine, based on the evaluation quantity or the measurement quantity of the service area, whether to perform low-power cell reselection-related measurement on a neighboring area whose priority is lower than or equal to a priority of the service area;
a parameter used to calculate the evaluation quantity of the service area;
a first reselection threshold, where the first reselection threshold is used to determine whether to perform low-power cell reselection to the neighboring area;
a second reselection threshold, where the second reselection threshold is used to determine whether to perform low-power cell reselection to the neighboring area whose priority is lower than the priority of the service area; and
a low-power cell reselection priority of the service area.

In some embodiments, the first parameter further includes:
a first evaluation period, where the first evaluation period is associated with at least one of the first measurement threshold and the second measurement threshold.

In some embodiments, the second parameter includes a hysteresis value.

In some embodiments, the configuration information of the first signal includes at least one of the following:
an identifier of the first signal;
a sequence corresponding to the first signal;
a format of the first signal;
a monitoring occasion of the first signal;
a cell reselection priority indicator in a low-power state of the first signal;
a frequency corresponding to the first signal;
a cell corresponding to the first signal; and
a radio access type corresponding to the first signal.

In some embodiments, the second configuration information further includes at least one of the following:
a third parameter corresponding to the neighboring area, where the third parameter is used to determine whether to perform low-power cell reselection;
a fourth parameter corresponding to the neighboring area, where the fourth parameter is used to determine a ranking of the service area in the low-power state of the terminal; and
a neighboring area monitoring occasion.

In some embodiments, the measurement results include an evaluation quantity, and the third parameter includes at least one of the following:
a parameter used to calculate an evaluation quantity of the neighboring area, where the evaluation quantity of the neighboring area is used to determine whether to perform low-power cell reselection to the neighboring area;
a third reselection threshold, where the third reselection threshold is used to determine whether to perform low-power cell reselection to the neighboring area;
a fourth reselection threshold, where the fourth reselection threshold is used to determine whether to perform low-power cell reselection to a first area, and the first area is a neighboring area whose priority is greater than a priority of the service area;
a fifth reselection threshold, where the fifth reselection threshold is used to determine whether to perform low-power cell reselection to a second area, and the second area is a neighboring area whose priority is equal to the priority of the service area;
a sixth reselection threshold, where the sixth reselection threshold is used to determine whether to perform low-power cell reselection to a third area, and the third area is a neighboring area whose priority is lower than the priority of the service area;
second evaluation duration, where the second evaluation duration is evaluation duration in which the terminal determines a reselectable neighboring area based on a target reselection manner; and a low-power cell reselection priority of the neighboring area.

In some embodiments, the fourth parameter includes an offset between areas.

In some embodiments, the neighboring area monitoring occasion is determined based on either of the following: a monitoring period; and a monitoring start position and monitoring duration.

In some embodiments, the measurement module 402 is configured to perform the following operations:
in a case that the terminal is in the low-power state, performing low-power cell reselection-related measurement on the first signal in the service area based on the first message, to obtain measurement results of the service area; and
performing low-power cell reselection-related measurement on first signals in N neighboring areas, where the N neighboring areas are determined based on the measurement results of the service area and a target measurement manner, and the target measurement manner is used to determine whether a neighboring area is to be measured.

In some embodiments, the measurement results include at least one of a measurement quantity and an evaluation quantity, and the target measurement manner includes at least one of the following:
performing low-power cell reselection-related measurement on the neighboring area when a measurement quantity or an evaluation quantity of the service area is less than or equal to a first measurement threshold; and
always performing low-power cell reselection-related measurement on a first area, and in a case that the measurement quantity or the evaluation quantity of the service area is less than or equal to a second measurement threshold, performing low-power cell reselection-related measurement on a second area and a third area; where
the first area is a neighboring area whose priority is greater than a priority of the service area, the second area is a neighboring area whose priority is equal to the priority of the service area, the third area is a neighboring area whose priority is lower than the priority of the service area, the first measurement threshold is used to determine, based on the measurement quantity or the evaluation quantity of the service area, whether to perform low-power cell reselection-related measurement on the neighboring area, and the second measurement threshold is used to determine, based on the measurement quantity or the evaluation quantity of the service area, whether to perform low-power cell reselection-related measurement on a neighboring area whose priority is equal to or lower than the priority of the service area.

In some embodiments, the reselection module 403 is configured to: in a case that the terminal leaves the low-power state, perform low-power cell reselection based on the measurement results and a target reselection manner; where
the target reselection manner is used to determine a reselectable neighboring area.

In some embodiments, the measurement results include at least one of a measurement quantity and an evaluation quantity, and the target reselection manner includes at least one of the following:
performing low-power cell reselection to the neighboring area in a case that a measurement quantity or an evaluation quantity of the neighboring area is greater than a third reselection threshold;
performing low-power cell reselection to the neighboring area in a case that a measurement quantity or an evaluation quantity of the service area is less than or equal to a first reselection threshold and a measurement quantity or an evaluation quantity of the neighboring area is greater than or equal to a third reselection threshold;
performing low-power cell reselection to a first area in a case that a measurement quantity or an evaluation quantity of the first area is greater than or equal to a fourth reselection threshold, where the first area is a neighboring area whose priority is greater than a priority of the service area;
performing low-power cell reselection to a second area in a case that a measurement quantity or an evaluation quantity of the second area is greater than or equal to a fifth reselection threshold, where the second area is a neighboring area whose priority is equal to a priority of the service area;
performing low-power cell reselection to a second area in a case that a measurement quantity or an evaluation quantity of the service area is less than or equal to a second reselection threshold and a measurement quantity or an evaluation quantity of the second area is greater than or equal to a fifth reselection threshold;
performing low-power cell reselection to a third area in a case that a measurement quantity or an evaluation quantity of the service area is less than or equal to a second reselection threshold and a measurement quantity or an evaluation quantity of the third area is greater than or equal to a sixth reselection threshold, where the third area is a neighboring area whose priority is lower than a priority of the service area; and
ranking the second area based on a target ranking manner, and performing low-power cell reselection to L second areas with higher rankings, where L is a positive integer; where
the first reselection threshold is used to determine whether to perform low-power cell reselection to the neighboring area, the second reselection threshold is used to determine whether to perform low-power cell reselection to a neighboring area whose priority is lower than the priority of the service area, the third reselection threshold is used to determine whether to perform low-power cell reselection to the neighboring area, the fourth reselection threshold is used to determine whether to perform low-power cell reselection to the first area, the fifth reselection threshold is used to determine whether to perform low-power cell reselection to the second area, and the sixth reselection threshold is used to determine whether to perform low-power cell reselection to the third area.

In some embodiments, the target ranking manner includes at least one of the following:
a ranking value of the service area is equal to a result of reference signal received quality of a first signal in the service area plus a hysteresis value of the service area, or a ranking value of the service area is equal to a result of reference signal received quality of a first signal in the service area plus a hysteresis value of the service area minus a temporary offset of the service area; and
a ranking value of the neighboring area is equal to a result of reference signal received quality of a first signal in the neighboring area minus an offset between areas, or a ranking value of the neighboring area is equal to a result of reference signal received quality of a first signal in the neighboring area minus an offset between areas and a temporary offset of the neighboring area.

In some embodiments, the measurement quantity satisfies at least one of the following:
in a case that a target area includes one first signal, a measurement quantity of the target area is a measurement quantity of the first signal; and
in a case that a target area includes at least two first signals, a measurement quantity of the target area is determined based on measurement quantities of the at least two first signals; where
the target area is the service area or the neighboring area.

In some embodiments, in a case that the target area includes at least two first signals, the measurement quantity of the target area satisfies at least one of the following:
the measurement quantity of the target area is a maximum measurement quantity in the measurement quantities of the at least two first signals, or the measurement quantity of the target area is a minimum measurement quantity in the measurement quantities of the at least two first signals, or the measurement quantity of the target area is an average value of the measurement quantities of the at least two first signals; and
the measurement quantity of the target area is a measurement quantity of a first signal with a highest measurement quantity priority in the at least two first signals.

In some embodiments, the priority satisfies at least one of the following:
in a case that a low-power cell reselection priority is configured for the target area, a priority of the target area is the low-power cell reselection priority; and
in a case that no low-power cell reselection priority is configured for the target area, a priority of the target area is determined based on at least one of the following: determining, by the terminal, that the priority of the target area is a highest priority, a lowest priority, or a preset priority; in a case that the target area includes one first signal and a cell reselection priority is configured for the first signal, determining the cell reselection priority of the first signal as the priority of the target area; in a case that the target area includes at least two first signals and a cell reselection priority is configured for only one of the first signals, determining the cell reselection priority of the first signal as the priority of the target area; and in a case that the target area includes at least two first signals and a cell reselection priority is configured for M first signals in the at least two first signals, determining a highest priority, a lowest priority, or a preset priority in cell reselection priorities of the M first signals as the priority of the target area, where M is an integer greater than 1; where
the target area is the service area or the neighboring area.

In some embodiments, the evaluation quantity includes at least one of the following:
an area selection received power value, where the area selection received power value is determined based on reference signal received power in the measurement quantity of the target area, and the target area is the service area or the neighboring area; and
an area selection quality value, where the area selection quality value is determined based on reference signal received quality in the measurement quantity of the target area.

In some embodiments, the reselection module 403 is configured to perform at least one of the following:
performing low-power cell reselection to N1 neighboring areas, where N1 is a positive integer, the N1 neighboring areas are determined based on the measurement results and at least one of a target ranking manner, a priority of an area, a target reselection manner, and a terminal implementation, and the target reselection manner is used to determine a reselectable neighboring area; and
performing a cell search in the service area and all neighboring areas based on any one of the following: searching for, in a first order, at least one of a frequency and a cell corresponding to each area in the service area and all the neighboring areas, where a neighboring area determined based on the target reselection manner is located before another neighboring area in the first order; searching for at least one of a frequency and a cell corresponding to each area in the service area and all the neighboring areas in descending order of priorities; searching for at least one of a frequency and a cell corresponding to each area in the service area and all the neighboring areas in descending order of strength of first signals; searching, based on an order determined by the terminal, for at least one of a frequency or a cell corresponding to each area in the service area and all the neighboring areas; and searching, based on a high-to-low order determined based on the target ranking manner, for at least one of a frequency and a cell corresponding to each area in the service area and all the neighboring areas.

In some embodiments, the reselection module 403 is configured to perform any one of the following:
in a case that N1 is equal to 1 and the N1 neighboring areas include at least two cells, controlling the terminal to exit a low-power working state, and after exiting the low-power working state, performing a cell search on frequencies corresponding to the N1 neighboring areas, or performing a cell search on a cell list associated with frequencies corresponding to the N1 neighboring areas;
in a case that N1 is equal to 1 and the N1 neighboring areas include one cell, controlling the terminal to exit a low-power working state, and camping on the cell after exiting the low-power working state;
in a case that N1 is greater than 1 and a target neighboring area in the N1 neighboring areas includes at least two cells, exiting, by the terminal, a low-power working state, and after exiting the low-power working state, performing a cell search on a frequency corresponding to the target neighboring area, or performing a cell search on a cell list associated with a frequency corresponding to the target neighboring area, where the target neighboring area is N2 neighboring areas determined based on the target ranking manner, and N2 is a positive integer less than or equal to N1; and
in a case that N1 is greater than 1, performing, by the terminal, a cell search in the N1 neighboring areas based on any one of the following: searching for at least one of a frequency and a cell corresponding to the neighboring area in descending order of priorities; searching for at least one of a frequency and a cell corresponding to the neighboring area in descending order of strength of first signals; searching, based on an order determined by the terminal, for at least one of a frequency and a cell corresponding to the neighboring area; and searching, based on a high-to-low order determined based on the target ranking manner, for at least one of a frequency and a cell corresponding to the neighboring area.

The cell reselection processing method provided in this embodiment of this application may be performed by a cell reselection processing apparatus. In this embodiment of this application, the cell reselection processing apparatus according to an embodiment of this application is described by using an example in which the cell reselection processing apparatus performs the cell reselection processing method.

Referring to FIG. 5, an embodiment of this application provides a cell reselection processing apparatus. As shown in FIG. 5, the cell reselection processing apparatus 500 includes:
a sending module 501, configured to send a first message related to low-power state to a terminal; where
the first message includes first configuration information and second configuration information, the first configuration information includes configuration information of a first signal in a service area, the second configuration information includes configuration information of a first signal in a neighboring area, and the first signal is capable of being used by the terminal to perform low-power cell reselection-related measurement in a low-power state.

In this embodiment of this application, before sending a low-power state cell reselection message by using the sending module 501, the cell reselection processing apparatus 500 may further determine content carried in the first message. In other words, the cell reselection processing apparatus 500 may further include a determining module, and the determining module is configured to determine the content carried in the first message, for example, the determining module is configured to determine the first configuration information and the second configuration information.

In some embodiments, the first configuration information further includes at least one of the following:
a first parameter corresponding to the service area, where the first parameter is used to determine whether to perform low-power cell reselection; and
a second parameter corresponding to the service area, where the second parameter is used to determine a ranking of the service area in a case that the terminal is in the low-power state.

In some embodiments, the measurement results include at least one of a measurement quantity and an evaluation quantity, and the first parameter includes at least one of the following:
a first measurement threshold, where the first measurement threshold is used to determine, based on an evaluation quantity or a measurement quantity of the service area, whether to perform low-power cell reselection-related measurement on the neighboring area, and the evaluation quantity of the service area is used to determine whether to perform low-power cell reselection and/or whether to perform low-power cell reselection-related measurement on the neighboring area;
a second measurement threshold, where the second measurement threshold is used to determine, based on the evaluation quantity or the measurement quantity of the service area, whether to perform low-power cell reselection-related measurement on a neighboring area whose priority is lower than or equal to a priority of the service area;
a parameter used to calculate the evaluation quantity of the service area;
a first reselection threshold, where the first reselection threshold is used to determine whether to perform low-power cell reselection to the neighboring area;
a second reselection threshold, where the second reselection threshold is used to determine whether to perform low-power cell reselection to the neighboring area whose priority is lower than the priority of the service area; and
a low-power cell reselection priority of the service area.

In some embodiments, the first parameter further includes:
a first evaluation period, where the first evaluation period is associated with at least one of the first measurement threshold and the second measurement threshold.

In some embodiments, the measurement quantity satisfies at least one of the following:
in a case that the service area includes one first signal, a measurement quantity of the service area is a measurement quantity of the first signal; and
in a case that the service area includes at least two first signals, a measurement quantity of the service area is determined based on measurement quantities of the at least two first signals.

In some embodiments, in a case that the service area includes at least two first signals, the measurement quantity of the service area satisfies at least one of the following:
the measurement quantity of the service area is a maximum measurement quantity in the measurement quantities of the at least two first signals, or the measurement quantity of the service area is a minimum measurement quantity in the measurement quantities of the at least two first signals, or the measurement quantity of the service area is an average value of the measurement quantities of the at least two first signals; and
the measurement quantity of the service area is a measurement quantity of a first signal with a highest measurement quantity priority in the at least two first signals.

In some embodiments, the second parameter includes a hysteresis value.

In some embodiments, the configuration information of the first signal includes at least one of the following:
an identifier of the first signal;
a sequence corresponding to the first signal;
a format of the first signal;
a monitoring occasion of the first signal;
a cell reselection priority indicator in a low-power state of the first signal;
a frequency corresponding to the first signal;
a cell corresponding to the first signal; and
a radio access type corresponding to the first signal.

In some embodiments, the second configuration information further includes at least one of the following:
a third parameter corresponding to the neighboring area, where the third parameter is used to determine whether to perform low-power cell reselection;
a fourth parameter corresponding to the neighboring area, where the fourth parameter is used to determine a ranking of the service area in the low-power state of the terminal; and
a neighboring area monitoring occasion.

In some embodiments, the measurement results include an evaluation quantity, and the third parameter includes at least one of the following:
a parameter used to calculate an evaluation quantity of the neighboring area, where the evaluation quantity of the neighboring area is used to determine whether to perform low-power cell reselection to the neighboring area;
a third reselection threshold, where the third reselection threshold is used to determine whether to perform low-power cell reselection to the neighboring area;
a fourth reselection threshold, where the fourth reselection threshold is used to determine whether to perform low-power cell reselection to a first area, and the first area is a neighboring area whose priority is greater than a priority of the service area;
a fifth reselection threshold, where the fifth reselection threshold is used to determine whether to perform low-power cell reselection to a second area, and the second area is a neighboring area whose priority is equal to the priority of the service area;
a sixth reselection threshold, where the sixth reselection threshold is used to determine whether to perform low-power cell reselection to a third area, and the third area is a neighboring area whose priority is lower than the priority of the service area;
second evaluation duration, where the second evaluation duration is evaluation duration in which the terminal determines a reselectable neighboring area based on a target reselection manner; and
a low-power cell reselection priority of the neighboring area.

In some embodiments, the fourth parameter includes an offset between areas.

In some embodiments, the neighboring area monitoring occasion is determined based on either of the following: a monitoring period; and a monitoring start position and monitoring duration.

In some embodiments, the priority satisfies at least one of the following:
in a case that a low-power cell reselection priority is configured for the target area, a priority of the target area is the low-power cell reselection priority; and
in a case that no low-power cell reselection priority is configured for the target area, a priority of the target area is determined based on any one of the following: determining that the priority of the target area is a highest priority, a lowest priority, or a preset priority; in a case that the target area includes one first signal and a cell reselection priority is configured for the first signal, determining the cell reselection priority of the first signal as the priority of the target area; in a case that the target area includes at least two first signals and a cell reselection priority is configured for only one of the first signals, determining the cell reselection priority of the first signal as the priority of the target area; and in a case that the target area includes at least two first signals and a cell reselection priority is configured for M first signals in the at least two first signals, determining a highest priority, a lowest priority, or a preset priority in cell reselection priorities of the M first signals as the priority of the target area, where M is an integer greater than 1; where
the target area is the service area or the neighboring area.

In some embodiments, the evaluation quantity includes at least one of the following:
an area selection received power value, where the area selection received power value is determined based on reference signal received power in the measurement quantity of the target area, and the target area is the service area or the neighboring area; and
an area selection quality value, where the area selection quality value is determined based on reference signal received quality in the measurement quantity of the target area.

The cell reselection apparatus and the cell reselection processing apparatus in the embodiments of this application each may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in the embodiments of this application.

The cell reselection apparatus and the cell reselection processing apparatus provided in the embodiments of this application can implement the processes implemented in the method embodiments of FIG. 2 and FIG. 3, and a same technical effect is achieved. To avoid repetition, details are not described herein again.

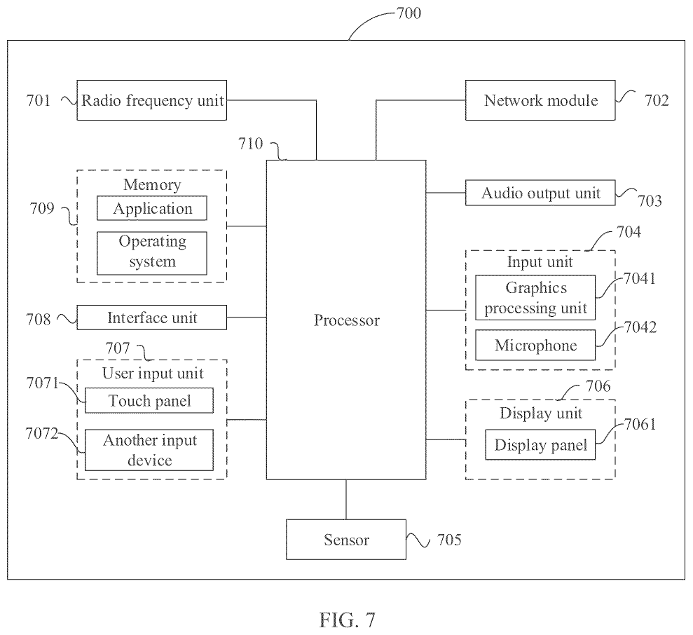

For example, as shown in FIG. 6, an embodiment of this application further provides a communication device 600, including a processor 601 and a memory 602, and the memory 602 stores a program or an instruction that can be run on the processor 601. For example, in a case that the communication device 600 is a terminal, when the program or the instruction is executed by the processor 601, the steps of the foregoing embodiment of the cell reselection method are implemented, and a same technical effect can be achieved. In a case that the communication device 600 is a network side device, when the program or the instruction is executed by the processor 601, the steps of the foregoing embodiment of the cell reselection processing method are implemented, and a same technical effect can be achieved. To avoid repetition, details are not described herein again.

An embodiment of this application further provides a terminal, including a processor and a communication interface. The communication interface is configured to receive a first message from a network side device, where the first message includes first configuration information and second configuration information, the first configuration information includes configuration information of a first signal in a service area, and the second configuration information includes configuration information of a first signal in a neighboring area. The processor is configured to: perform, in a case that the terminal is in a low-power state, low-power cell reselection-related measurement on the first signal based on the first message to obtain measurement results, where low-power cell reselection means to determine a to-be-camped-on cell after the terminal leaves the low-power state; and perform low-power cell reselection based on the measurement results in a case that the terminal leaves the low-power state. The terminal embodiment is corresponding to the method embodiment on the terminal side, each implementation process and implementation of the method embodiment can be applied to the terminal embodiment, and a same technical effect can be achieved. For example, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM, a Synch Link DRAM (SLDRAM), and a Direct Rambus RAM (DRRAM). The memory 709 in this embodiment of this application includes but is not limited to these memories and any memory of another proper type.

The processor 710 may include one or more processing units. In some embodiments, an application processor and a modem processor are integrated into the processor 710. The application processor mainly processes an operating system, a user interface, an application, or the like. The modem processor mainly processes a wireless communication signal, for example, a baseband processor. It may be understood that the modem processor may not be integrated into the processor 710.

The radio frequency unit 701 is configured to receive a first message from a network side device, where the first message includes first configuration information and second configuration information, the first configuration information includes configuration information of a first signal in a service area, and the second configuration information includes configuration information of a first signal in a neighboring area.

The processor 710 is configured to: perform, in a case that a terminal is in a low-power state, low-power cell reselection-related measurement on the first signal based on the first message, to obtain measurement results, where low-power cell reselection means to determine a to-be-camped-on cell after the terminal leaves the low-power state; and perform low-power cell reselection based on the measurement results in a case that the terminal leaves the low-power state.

In this embodiment of this application, because the configuration information of the first signal in the service area and the configuration information of the first signal in the neighboring area are configured for the terminal by using the first message, it can be ensured that the terminal can work normally in a low-power working state. Therefore, the terminal may measure the first signal when the terminal is in the low-power working state, and may be directly reselected to a target cell based on measurement results, or may perform a cell search on one or more areas targetedly, and be reselected to a target cell, thereby reducing a delay of cell reselection.

An embodiment of this application further provides a network side device, including a processor and a communication interface. The communication interface is configured to send a first message related to low-power state to a terminal, where the first message includes first configuration information and second configuration information, the first configuration information includes configuration information of a first signal in a service area, the second configuration information includes configuration information of a first signal in a neighboring area, and the first signal is capable of being used by the terminal to perform low-power cell reselection-related measurement in a low-power state. This network side device embodiment is corresponding to the foregoing method embodiment of the network side device. Each implementation process and implementation of the foregoing method embodiment may be applicable to this network side device embodiment, and a same technical effect can be achieved.

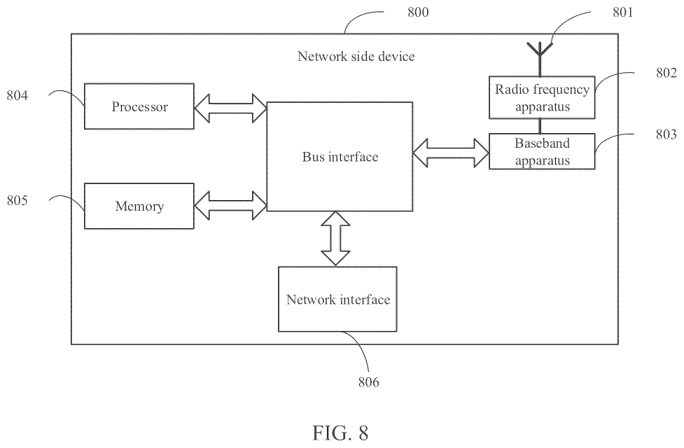

For example, an embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a Common Public Radio Interface (CPRI).

For example, the network side device 800 in this embodiment of the present disclosure further includes an instruction or a program that is stored in the memory 805 and that can be run on the processor 804. The processor 804 invokes the instruction or the program in the memory 805 to perform the method performed by the modules shown in FIG. 5, and a same technical effect is achieved. To avoid repetition, details are not described herein again.

An embodiment of this application further provides a readable storage medium. A program or an instruction is stored in the readable storage medium. When the program or the instruction is executed by a processor, the processes of the embodiment of the cell reselection method or the cell reselection processing method can be implemented, and a same technical effect can be achieved. To avoid repetition, details are not described herein.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the cell reselection method or the cell reselection processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the cell reselection method or the cell reselection processing method, and a same technical effect can be achieved. To avoid repetition, details are not described herein again.

An embodiment of this application further provides a communication system, including a terminal and a network side device. The terminal is configured to perform the processes of the foregoing embodiment of the cell reselection method and FIG. 2, and the network side device is configured to perform the processes of the foregoing embodiment of the cell reselection processing method and FIG. 3, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application entirely or the part contributing to the prior art may be implemented in a form of a computer software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. A cell reselection method, comprising:
receiving, by a terminal, a first message from a network side device,
wherein:
the first message comprises first configuration information and second configuration information,
the first configuration information comprises configuration information of a first signal in a service area, and
the second configuration information comprises configuration information of a first signal in a neighboring area;
performing, by the terminal when the terminal is in a low-power state, low-power cell reselection-related measurement on the first signal based on the first message, to obtain measurement results, wherein low-power cell reselection means to determine a to-be-camped-on cell after the terminal leaves the low-power state; and
performing, by the terminal, low-power cell reselection based on the measurement results when the terminal leaves the low-power state.

2. The cell reselection method according to claim 1, wherein the first configuration information further comprises either of the following:
a first parameter corresponding to the service area, wherein the first parameter is used to determine whether to perform low-power cell reselection; or
a second parameter corresponding to the service area, wherein the second parameter is used to determine a ranking of the service area when the terminal is in the low-power state.

3. The cell reselection method according to claim 2, wherein the measurement results comprise at least one of a measurement quantity or an evaluation quantity, and the first parameter comprises at least one of the following:
a first measurement threshold, wherein the first measurement threshold is used to determine, based on an evaluation quantity or a measurement quantity of the service area, whether to perform low-power cell reselection-related measurement on the neighboring area, and the evaluation quantity of the service area is used to determine whether to perform low-power cell reselection or whether to perform low-power cell reselection-related measurement on the neighboring area;
a second measurement threshold, wherein the second measurement threshold is used to determine, based on the evaluation quantity or the measurement quantity of the service area, whether to perform low-power cell reselection-related measurement on a neighboring area whose priority is lower than or equal to a priority of the service area;
a parameter used to calculate the evaluation quantity of the service area;
a first reselection threshold, wherein the first reselection threshold is used to determine whether to perform low-power cell reselection to the neighboring area;
a second reselection threshold, wherein the second reselection threshold is used to determine whether to perform low-power cell reselection to the neighboring area whose priority is lower than the priority of the service area; or
a low-power cell reselection priority of the service area.

4. The cell reselection method according to claim 3, wherein the first parameter further comprises:
first evaluation duration, wherein the first evaluation duration is associated with at least one of the first measurement threshold or the second measurement threshold.

5. The cell reselection method according to claim 2, wherein the second parameter comprises a hysteresis value.

6. The cell reselection method according to claim 1, wherein the configuration information of the first signal comprises at least one of the following:
an identifier of the first signal;
a sequence corresponding to the first signal;
a format of the first signal;
a monitoring occasion of the first signal;
a cell reselection priority indicator in a low-power state of the first signal;
a frequency corresponding to the first signal;
a cell corresponding to the first signal; or
a radio access type corresponding to the first signal.

7. The cell reselection method according to claim 1, wherein the second configuration information further comprises at least one of the following:
a third parameter corresponding to the neighboring area, wherein the third parameter is used to determine whether to perform low-power cell reselection;
a fourth parameter corresponding to the neighboring area, wherein the fourth parameter is used to determine a ranking of the service area in the low-power state of the terminal; or
a neighboring area monitoring occasion.

8. The cell reselection method according to claim 7, wherein the measurement results comprise an evaluation quantity, and the third parameter comprises at least one of the following:
a parameter used to calculate an evaluation quantity of the neighboring area, wherein the evaluation quantity of the neighboring area is used to determine whether to perform low-power cell reselection to the neighboring area;
a third reselection threshold, wherein the third reselection threshold is used to determine whether to perform low-power cell reselection to the neighboring area;
a fourth reselection threshold, wherein the fourth reselection threshold is used to determine whether to perform low-power cell reselection to a first area, and the first area is a neighboring area whose priority is greater than a priority of the service area;
a fifth reselection threshold, wherein the fifth reselection threshold is used to determine whether to perform low-power cell reselection to a second area, and the second area is a neighboring area whose priority is equal to the priority of the service area;
a sixth reselection threshold, wherein the sixth reselection threshold is used to determine whether to perform low-power cell reselection to a third area, and the third area is a neighboring area whose priority is lower than the priority of the service area;
second evaluation duration, wherein the second evaluation duration is evaluation duration in which the terminal determines a reselectable neighboring area based on a target reselection manner; or
a low-power cell reselection priority of the neighboring area.

9. The cell reselection method according to claim 7, wherein the fourth parameter comprises an offset between areas.

10. The cell reselection method according to claim 7, wherein the neighboring area monitoring occasion is determined based on either of the following: a monitoring period; or a monitoring start position and monitoring duration.

11. The cell reselection method according to claim 1, wherein performing, by the terminal when the terminal is in the low-power state, the low-power cell reselection-related measurement on the first signal based on the first message, to obtain the measurement results comprises:
when the terminal is in the low-power state, performing, by the terminal, the low-power cell reselection-related measurement on the first signal in the service area based on the first message, to obtain measurement results of the service area; and
performing, by the terminal, the low-power cell reselection-related measurement on first signals in N neighboring areas, wherein the N neighboring areas are determined based on the measurement results of the service area and a target measurement manner, and the target measurement manner is used to determine whether a neighboring area is to be measured.

12. The cell reselection method according to claim 11, wherein the measurement results comprise at least one of a measurement quantity or an evaluation quantity, and the target measurement manner comprises at least one of the following:
performing low-power cell reselection-related measurement on the neighboring area when a measurement quantity or an evaluation quantity of the service area is less than or equal to a first measurement threshold; or
always performing low-power cell reselection-related measurement on a first area, and when the measurement quantity or the evaluation quantity of the service area is less than or equal to a second measurement threshold, performing low-power cell reselection-related measurement on a second area and a third area,
wherein:
the first area is a neighboring area whose priority is greater than a priority of the service area,
the second area is a neighboring area whose priority is equal to the priority of the service area,
the third area is a neighboring area whose priority is lower than the priority of the service area,
the first measurement threshold is used to determine, based on the measurement quantity or the evaluation quantity of the service area, whether to perform low-power cell reselection-related measurement on the neighboring area, and
the second measurement threshold is used to determine, based on the measurement quantity or the evaluation quantity of the service area, whether to perform low-power cell reselection-related measurement on a neighboring area whose priority is equal to or lower than the priority of the service area.

13. The cell reselection method according to claim 1, wherein performing, by the terminal, the low-power cell reselection based on the measurement results when the terminal leaves the low-power state comprises:
when the terminal leaves the low-power state, performing, by the terminal, the low-power cell reselection based on the measurement results and a target reselection manner; wherein
the target reselection manner is used to determine a reselectable neighboring area.

14. The cell reselection method according to claim 3, wherein the measurement quantity satisfies at least one of the following:
when a target area comprises one first signal, a measurement quantity of the target area is a measurement quantity of the first signal; or
when a target area comprises at least two first signals, a measurement quantity of the target area is determined based on measurement quantities of the at least two first signals; wherein
the target area is the service area or the neighboring area.

15. The cell reselection method according to claim 1, wherein performing, by the terminal, the low-power cell reselection based on the measurement results when the terminal leaves the low-power state comprises either of the following:
performing, by the terminal, low-power cell reselection to N1 neighboring areas,
wherein:
N1 is a positive integer,
the N1 neighboring areas are determined based on the measurement results and at least one of a target ranking manner, a priority of an area, a target reselection manner, or a terminal implementation, and
the target reselection manner is used to determine a reselectable neighboring area; or
performing, by the terminal, a cell search in the service area and all neighboring areas based on any one of the following:
searching for, in a first order, at least one of a frequency or a cell corresponding to each area in the service area and all the neighboring areas, wherein a neighboring area determined based on the target reselection manner is located before another neighboring area in the first order;
searching for at least one of a frequency or a cell corresponding to each area in the service area and all the neighboring areas in descending order of priorities;
searching for at least one of a frequency or a cell corresponding to each area in the service area and all the neighboring areas in descending order of strength of first signals;
searching, based on an order determined by the terminal, for at least one of a frequency or a cell corresponding to each area in the service area and all the neighboring areas; and
searching, based on a high-to-low order determined based on the target ranking manner, for at least one of a frequency or a cell corresponding to each area in the service area and all the neighboring areas.

16. A cell reselection processing method, comprising:
sending, by a network side device, a first message related to low-power state to a terminal; wherein:
the first message comprises first configuration information and second configuration information,
the first configuration information comprises configuration information of a first signal in a service area,
the second configuration information comprises configuration information of a first signal in a neighboring area, and
the first signal is capable of being used by the terminal to perform low-power cell reselection-related measurement in a low-power state.

17. The cell reselection processing method according to claim 16, wherein the first configuration information further comprises at least one of the following:
a first parameter corresponding to the service area, wherein the first parameter is used to determine whether to perform low-power cell reselection; or
a second parameter corresponding to the service area, wherein the second parameter is used to determine a ranking of the service area when the terminal is in the low-power state.

18. The cell reselection processing method according to claim 17, wherein the measurement results comprise at least one of a measurement quantity or an evaluation quantity, and the first parameter comprises at least one of the following:
a first measurement threshold, wherein the first measurement threshold is used to determine, based on an evaluation quantity or a measurement quantity of the service area, whether to perform low-power cell reselection-related measurement on the neighboring area, and the evaluation quantity of the service area is used to determine whether to perform low-power cell reselection or whether to perform low-power cell reselection-related measurement on the neighboring area;
a second measurement threshold, wherein the second measurement threshold is used to determine, based on the evaluation quantity or the measurement quantity of the service area, whether to perform low-power cell reselection-related measurement on a neighboring area whose priority is lower than or equal to a priority of the service area;
a parameter used to calculate the evaluation quantity of the service area;
a first reselection threshold, wherein the first reselection threshold is used to determine whether to perform low-power cell reselection to the neighboring area;
a second reselection threshold, wherein the second reselection threshold is used to determine whether to perform low-power cell reselection to the neighboring area whose priority is lower than the priority of the service area; or
a low-power cell reselection priority of the service area.

19. The cell reselection processing method according to claim 18, wherein the first parameter further comprises:
first evaluation duration, wherein the first evaluation duration is associated with at least one of the first measurement threshold or the second measurement threshold.

20. A terminal, comprising: a processor; and a memory having a computer program or an instruction stored thereon, wherein the computer program or the instruction, when executed by the processor, causes the processor to perform operations comprising:
receiving a first message from a network side device,
wherein:
the first message comprises first configuration information and second configuration information,
the first configuration information comprises configuration information of a first signal in a service area, and
the second configuration information comprises configuration information of a first signal in a neighboring area;
when the terminal is in a low-power state, performing low-power cell reselection-related measurement on the first signal based on the first message, to obtain measurement results, wherein low-power cell reselection means to determine a to-be-camped-on cell after the terminal leaves the low-power state; and
performing low-power cell reselection based on the measurement results when the terminal leaves the low-power state.
